(19) United States
(12) Patent Application Publication
(10) Pub. No.: US 2025/0187575 A1
(43) Pub. Date: Jun. 12, 2025

(54) BRAKE SYSTEM OF A VEHICLE WITH REDUNDANT PARKING BRAKE FUNCTION

(71) Applicant: KNORR-BREMSE Systeme für Nutzfahrzeuge GmbH, Munich (DE)

(72) Inventors: Jonas Fleischer, Leonberg (DE); Oliver Jundt, Hessigheim (DE); Falk Hecker, Markgröningen (DE)

(21) Appl. No.: 18/969,762

(22) Filed: Dec. 5, 2024

(30) Foreign Application Priority Data
Dec. 6, 2023 (DE) 102023134202.9

(51) Int. Cl. B60T 13/68; B60T 7/20

(52) U.S. Cl. CPC B60T 13/683; B60T 7/20; B60T 2270/413

(57) ABSTRACT

A brake system of a vehicle, having an electro-pneumatic parking brake installation with a parking brake module and a parking brake function, an electro-pneumatic service brake installation with at least one electro-pneumatic service brake circuit, and a redundant parking brake function implemented in a controller. The redundant parking brake function is configured so that, upon recognizing the standstill of the vehicle and upon recognizing a fault or a defect in the parking brake circuit that causes the non-energized state of the parking brake module, it optionally actuates a first solenoid valve installation so as to apply, or keep in an applied state, at least one first service brake cylinder, and optionally simultaneously or thereafter actuates a second solenoid valve installation so as to direct compressed air into the second service brake cylinder.

The invention relates to a brake system of a vehicle, having an electro-pneumatic parking brake installation with a parking brake function, an electro-pneumatic service brake installation with at least one electro-pneumatic service brake circuit, and having a redundant parking brake function which is implemented in a controller, wherein a holding force for holding the vehicle when at a standstill is in each case able to be generated with the aid of the parking brake function and the redundant parking brake function, as claimed in claim 1. Moreover, as claimed in claim 25, the invention also relates to a vehicle having at least one such brake system.

In particular vehicles with autonomous driving systems, which facilitate driverless travel, are in most instances equipped with redundant electro-pneumatic service brake installations, wherein the redundancy takes over when the electro-pneumatic service brake installation has failed. Even when such a vehicle has been decelerated to a standstill by a (redundant) electro-pneumatic service brake installation and is then kept at a standstill by the latter, reliable standstill is not guaranteed in this way. This is because the braking effect of an electro-pneumatic service brake installation diminishes after some time due to leakages, this also being promoted due to the fact that no additional reservoir compressed air is conveyed into the at least one pressurized reservoir vessel by the compressor once the engine has been switched off.

It is therefore desirable also to provide a redundancy for the parking brake function when the parking brake function has failed, for example due to a power failure or due to an electrical fault or defect in the parking brake installation. This is because, in particular in the case of vehicles with autonomous driving systems, there is typically no driver to intervene in order to guarantee safe parking of the vehicle, for example. Therefore, it is to be ensured in particular under all circumstances that the vehicle can be kept at a standstill by way of the spring-accumulator brake cylinder. The redundant parking brake function is in particular to function independently of the functional reliability of an electronic parking brake controller.

Therefore, the object of the invention lies in designing the brake system in such a manner that reliable parking of the vehicle is possible using the parking brake installation. Furthermore, the intention is also to provide a vehicle having such a brake system.

This object is achieved by the features of claims 1 and 25.

### DISCLOSURE OF THE INVENTION

The invention discloses a brake system of a vehicle, having an electro-pneumatic parking brake installation with a parking brake function, an electro-pneumatic service brake installation with at least one electro-pneumatic service brake circuit, and having a redundant parking brake function which is implemented in at least one controller and is carried out in particular when the parking brake function has failed, wherein a holding force for holding the vehicle at a standstill is in each case able to be generated with the aid of the parking brake function and the redundant parking brake function.

“Electro-pneumatic” is understood mean that controlling the respective installation is performed electrically or electronically, but the working medium is compressed air.

“Redundant parking brake function” is understood to mean in particular that in this instance the usual parking brake function used in normal operation no longer functions and is then replaced by the redundant parking brake function. The application of the parking brake in the parking brake function as well as in the redundant parking brake function takes place by venting the at least one spring-accumulator brake cylinder to at least the application pressure of the latter.

In particular provided within the service brake installation is (are) at least one electro-pneumatic service brake circuit, preferably two service brake circuits, a first service brake circuit for the front axle of the vehicle, and a second service brake circuit for the rear axle, wherein a common pressurized reservoir vessel can be provided for both brake circuits, or a dedicated pressurized reservoir vessel may be provided for each brake circuit.

The electro-pneumatic service brake installation comprises at least one first service brake cylinder assigned to a first wheel of the vehicle, at least one electronic service brake controller, at least one pressurized reservoir vessel, and a first solenoid valve installation which is able to be controlled by the at least one electronic service brake controller and by the redundant parking brake function.

The first solenoid valve installation is (fundamentally) designed and specified so that compressed air from the at least one pressurized reservoir vessel can be directed into the at least one first service brake cylinder and simultaneously, or temporally overlapping, compressed air from the at least one first service brake cylinder can be directed into a pressure sink.

The parking brake installation comprises an electro-pneumatic parking brake circuit which is supplied with compressed air exclusively by the at least one pressurized reservoir vessel and has at least one pneumatically controlled spring-accumulator brake cylinder, an electronic parking brake controller, and has an inlet/outlet solenoid valve combination, which is controlled by the electronic parking brake controller, for at least aerating and venting the at least one spring-accumulator brake cylinder, and is designed in such a manner that, in the non-energized state, it connects the at least one spring-accumulator brake cylinder to the at least one pressurized reservoir vessel.

The redundant parking brake function is designed so that, at least upon recognizing a fault or a defect in the parking brake circuit that causes the non-energized state of the inlet/outlet solenoid valve combination, it actuates the first solenoid valve installation in the context of a pressure reduction mode so as to direct compressed air from the at least one pressurized reservoir vessel into the first service brake cylinder and simultaneously, or temporally overlapping, to direct compressed air from the first service brake cylinder into the pressure sink. Therefore, the reservoir pressure in the at least one pressurized reservoir vessel in the pressure reduction mode is lowered or reduced in such a manner that the at least one spring-accumulator brake cylinder is applied as a result.

The service brake installation, or the at least one electro-pneumatic service brake circuit, comprises in particular at least one first service brake cylinder assigned to a first wheel of the vehicle, and optionally at least one second service brake cylinder assigned to a second wheel of the vehicle, at least one electronic service brake controller, at least one pressurized reservoir vessel, and a first solenoid valve installation which is controlled by the at least one electronic service brake controller, and optionally also a second solenoid valve installation.

The first solenoid valve installation is designed so that, with the aid of the first solenoid valve installation, compressed air from the at least one pressurized reservoir vessel can be directed into the at least one first service brake cylinder and simultaneously, or temporally overlapping, compressed air from the at least one first service brake cylinder can be directed into a pressure sink. The optional second solenoid valve installation is designed so that, with the aid of the second solenoid valve installation, a second service brake pressure in the at least one second service brake cylinder can be maintained, increased or lowered.

The first service brake cylinder and the second service brake cylinder can be disposed, for example, on different axles, or on the same axle, and in terms of the vehicle side on the same vehicle side or on different vehicle sides. To this extent, the first service brake cylinder and the second service brake cylinder may both be part of a common electro-pneumatic service brake circuit, or else be associated with only one electro-pneumatic service brake circuit.

The first solenoid valve installation and/or the second solenoid valve installation can comprise, for example, at least one inlet valve and at least one outlet valve. The terms “inlet valve” and “outlet valve” are to be understood in a wide sense. Consequently, “inlet valve” means any valve with the aid of which compressed air from the pressurized reservoir vessel here can make its way into the first or the second service brake cylinder. The term “outlet valve” also means any valve with the aid of which compressed air can be directed from the first or the second service brake cylinder into the pressure sink. In particular, the “inlet valve” and/or the “outlet valve” can have at least two connectors, and at least two switching positions.

The first solenoid valve installation and/or the second solenoid valve installation can in particular comprise an inlet valve and an outlet valve of at least one ABS pressure control valve and/or of a pressure regulator module.

For example, the first solenoid valve installation, the at least one first service brake cylinder, optionally a first pressurized reservoir vessel and the at least one first wheel can be included in a first electro-pneumatic service brake circuit, and the second solenoid valve installation, the at least one second service brake cylinder, optionally a second pressurized reservoir vessel and the at least one second wheel can be included in a second electro-pneumatic service brake circuit. Preferably, the first electro-pneumatic service brake circuit is a rear axle service brake circuit having, for example, two first wheels with in each case one assigned first service brake cylinder, and the second electro-pneumatic service brake circuit is a front axle service brake circuit having, for example, two second wheels with in each case one assigned second service brake cylinder. In particular, there may be two pressurized reservoir vessels, presently specifically the first and the second pressurized reservoir vessel, from which the parking brake circuit is exclusively supplied. Alternatively, the supply of the parking brake circuit is also possible exclusively from the first pressurized reservoir vessel or from the second pressurized reservoir vessel.

Furthermore, the parking brake installation of the brake system contains an electro-pneumatic parking brake circuit which is supplied with compressed air exclusively by the at least one pressurized reservoir vessel of the service brake installation, or of the at least one electro-pneumatic service brake circuit of the service brake installation and which has at least one pneumatically controlled passive spring-accumulator brake cylinder, an electronic parking brake controller, and has an inlet/outlet solenoid valve combination which is at least for aerating and venting the at least one spring-accumulator brake cylinder and is controlled by the electronic parking brake controller. In this way, the at least one pressurized reservoir vessel is a common pressurized reservoir vessel which supplies the parking brake circuit and simultaneously the electro-pneumatic service brake installation or at least one service brake circuit of the electro-pneumatic service brake installation. It is also possible that a first service brake circuit comprises a first pressurized reservoir vessel, and a second service brake circuit comprises a second pressurized reservoir vessel, and the parking brake circuit is supplied with compressed air by the first pressurized reservoir vessel and/or by the second pressurized reservoir vessel.

The inlet/outlet solenoid valve combination of the parking brake circuit is designed in such a manner that, in a non-energized state, it connects the at least one spring-accumulator brake cylinder to the at least one pressurized reservoir vessel of the electro-pneumatic service brake installation, or of the at least one electro-pneumatic service brake circuit.

Consequently, in the non-energized state of the inlet/outlet solenoid valve combination, the at least one spring-accumulator brake cylinder is aerated, and venting 41 the latter is prevented. This is provided in particular for safety reasons, on the one hand, because it is thereby prevented in a vehicle in motion that in the event of a power failure or a fault or a defect in the electronic parking brake controller, or in electrical connections between the latter and the inlet/outlet solenoid valve combination, the at least one spring-accumulator brake cylinder is suddenly vented, thus causing an unstable driving situation. Maintaining the venting action by the non-energized inlet/outlet solenoid valve combination, which is preferably provided for safety reasons, is then advantageously utilized by the invention for the redundant parking brake function in the manner described further below.

According to one preferred embodiment, at least one first sensor is moreover provided, by way of which it can be established whether the vehicle is at a standstill (or in motion), wherein the first sensor inputs a corresponding first sensor signal into the at least one electronic controller for evaluation by the redundant parking brake function. The electronic controller can therefore establish with the aid of the first sensor signal whether the vehicle is at a standstill (or in motion). The at least one first sensor comprises in particular at least one wheel rotating speed sensor. Because the standstill of the vehicle cannot be differentiated from travel at very low speeds (approx. 0 to 5 km/h) using simple wheel rotating speed sensors, “standstill of the vehicle” is understood to mean a range from approx. 0 km/h to 5 km/h.

Furthermore, the redundant parking brake function implemented in the electronic controller is designed so that, upon recognizing a fault or defect in the parking brake circuit that causes the non-energized state of the inlet/outlet solenoid valve combination, and optionally additionally when recognizing the standstill of the vehicle by means of the first sensor signal, it optionally activates the second solenoid valve installation so as to apply the at least one second service brake cylinder or to keep the latter in an applied state, and optionally simultaneously or thereafter, actuates the first solenoid valve installation in the context of the pressure reduction mode so as to direct compressed air from the at least one pressurized reservoir vessel into the first service brake cylinder and simultaneously, or temporally overlapping, direct compressed air from the first service brake cylinder into the pressure sink, so as to lower the reservoir pressure in the at least one pressurized reservoir vessel and to apply the at least one spring-accumulator brake cylinder.

The at least one second service brake cylinder, which is compressed air-controlled by the second solenoid valve installation, is therefore optionally (in particular initially) applied, or kept in the applied state if already applied, in the context of the redundant parking brake function so as to generate a (particularly temporary) holding force.

In normal operation, the reservoir pressure in the at least one pressurized reservoir vessel, to which the at least one spring-accumulator brake cylinder is connected by way of the inlet/outlet solenoid valve combination, is greater than the application pressure of the at least one spring-accumulator brake cylinder. This application pressure represents a relatively low pressure in a brake chamber of the at least one spring-accumulator brake cylinder, this pressure then working counter to the spring force of at least one accumulator spring of the at least one spring-accumulator brake cylinder.

According to one embodiment, when the at least one controller in the context of the redundant parking brake function then activates the first solenoid valve installation so as to direct compressed air from the at least one pressurized reservoir vessel into the at least one first service brake cylinder and simultaneously, or temporally overlapping, direct compressed air from the first service brake cylinder into the pressure sink, the pressure in the at least one pressurized reservoir vessel then drops to the application pressure, or below the latter, due to the consumption of compressed air caused thereby, so that the at least one spring-accumulator brake cylinder, which is supplied with compressed air solely from the at least one pressurized reservoir vessel, is applied as a result and generates the required holding force which can then keep the vehicle at a standstill.

The first solenoid valve installation assigned to the at least one first wheel, and the at least one first service brake cylinder which is controlled with compressed air by the first solenoid valve installation, are therefore utilized for venting the at least one pressurized reservoir vessel in the context of the redundant parking brake function. The first service brake pressure which is generated by the first solenoid valve installation and is input into the at least one first service brake cylinder, then corresponds substantially to the parking brake pressure in the at least one spring-accumulator brake cylinder.

In other words, in the context of the redundant parking brake function, in the event of a fault or defect being detected in the parking brake circuit, and optionally in the event of an established standstill of the vehicle, the second service brake cylinder is optionally applied or kept applied by the second service brake pressure, initially on at least one second wheel, whereby the vehicle can be kept at a standstill (in particular initially) as a result of the applied at least one second service brake cylinder. This procedure preferably takes place on a plurality of second wheels of the vehicle, or on a plurality of second service brake cylinders of the vehicle, so as to generate a uniform distribution of braking force and/or a high holding braking force.

Optionally simultaneously or thereafter, the reservoir pressure in the at least one pressurized reservoir vessel, which supplies compressed air to the parking brake installation with its parking brake circuit, as well as to the electro-pneumatic service brake installation with its at least one service brake circuit, is preferably reduced to at least the application pressure of the at least one spring-accumulator brake cylinder in order to apply the latter. This procedure consequently imitates a “consumption” of compressed air, for example in one service brake circuit or in a plurality of service brake circuits, and is preferably carried out on a plurality of first service brake cylinders so as to achieve as rapid venting of the common pressurized reservoir vessel as possible, so that the at least one spring-accumulator brake cylinder can be applied as rapidly as possible. The redundant parking brake function therefore comprises in particular a single application of the at least one spring-accumulator brake cylinder, or is preferably limited to such a single application.

This is where the characteristic of the inlet/outlet solenoid valve combination of the parking brake circuit, which is described above and provided essentially for safety reasons, comes to bear, whereby said inlet/outlet solenoid valve combination, when non-energized, i.e. presently in the event of an electrical or electronic defect or fault in the parking brake circuit, for example, connects the at least one spring-accumulator brake cylinder to the common pressurized reservoir vessel.

The controller is preferably designed so that it prevents compressed air in the common pressurized reservoir vessel being topped up, for example by a compressor of the brake system that is driven by a drive machine. This can be implemented, for example, in that the controller only activates, puts into operation or carries out the redundant parking brake function when an ignition switch of the drive machine is switched off. The controller in which the redundant parking brake function is implemented can be supplied with a current in particular from a (dedicated) current supply which supplies current to the controller independently of any activation of the ignition switch.

The venting of the at least one common pressurized reservoir vessel for the service brake installation, or the at least one service brake circuit and the parking brake circuit, is therefore associated with an application of the at least one spring-accumulator brake cylinder, on the one hand, but also a gradual release of the at least one second service brake cylinder, by way of which the vehicle has optionally been initially kept at a standstill. Consequently, a temporal transition from holding the vehicle by the at least one applied second service brake cylinder to holding by the at least one applied spring-accumulator brake cylinder is preferably performed by the redundant parking brake function. Therefore, the holding force generated by the at least one second service brake cylinder decreases during a transition interval, while the holding force generated by the at least one spring-accumulator brake cylinder increases. However, the at least one first service brake cylinder may not contribute, or may contribute only insignificantly, toward generating the holding force, because it is supplied by the common pressurized reservoir vessel and is therefore likewise vented.

Alternatively, optionally temporarily holding the vehicle by the at least one applied second service brake cylinder can also be dispensed with, because the first service brake pressure drops as a result of the consumption of compressed air in the at least one common pressurized reservoir vessel for the at least one service brake circuit and the parking brake circuit, on the one hand, but the parking brake pressure in the parking brake circuit also drops approximately to the same extent, on the other hand, so that decelerating the vehicle to a standstill and/or holding the vehicle at a standstill is possible due to the resultant reduction of the service braking force and the increase of the parking braking force.

It is obvious that the redundant parking brake function implemented in the controller comprises software by way of which the control functions described above are carried out. Likewise, there are corresponding line and signal connections between the controller, on the one hand, and the actuators and the sensors, on the other hand.

In order to achieve independence between the controller and the parking brake control electronics, the controller is preferably supplied with an electric current by a second voltage supply which is independent from a first voltage supply of the parking brake control electronics.

It is also favorable that the first pressurized reservoir vessel, which supplies the first solenoid valve installation so as to generate the first service brake pressure in the at least one first service brake cylinder as a function of the reservoir pressure in the first pressurized reservoir vessel, is assigned to a first service brake circuit and is separate from and independent of the second pressurized reservoir vessel, which supplies the second solenoid valve installation so as to generate the second service brake pressure in the at least one second service brake cylinder as a function of the reservoir pressure in the second pressurized reservoir vessel.

Overall, the redundant parking brake function described above leads to an improvement in the operational safety of the brake system.

At least one second sensor which directly or indirectly determines or measures reservoir pressure prevalent in the at least one pressurized reservoir vessel and inputs a corresponding reservoir pressure signal for evaluation by the redundant parking brake function into the electronic controller can also be provided in the brake system. This can be understood to mean that the prevailing reservoir pressure in the common pressurized reservoir vessel for the at least one service brake circuit and the parking brake circuit is measured, for example by means of a pressure sensor, the latter in this instance forming the second sensor.

In this instance, the redundant parking brake function implemented in the controller can be designed so that it actuates the first solenoid valve installation at least for the duration so as to direct compressed air from the at least one pressurized reservoir vessel into the first service brake cylinder and simultaneously, or temporally overlapping, to direct compressed air from the first service brake cylinder into the pressure sink, until said redundant parking brake function can establish by means of the reservoir pressure signal that the reservoir pressure in the at least one pressurized reservoir vessel has dropped to a pressure lower than or equal to the application pressure of the at least one spring-accumulator brake cylinder.

Furthermore, the redundant parking brake function implemented in the controller can be designed so that, upon establishing that the reservoir pressure in the pressurized reservoir vessel has dropped to a pressure which is lower than or equal to the application pressure of the at least one spring-accumulator brake cylinder, it actuates the second solenoid valve installation so as to release the at least one second service brake cylinder. This is because the vehicle is then kept at a standstill with a sufficient holding force by the at least one spring-accumulator brake cylinder, so that it is no longer necessary for the at least one second service brake cylinder to be kept in the applied state. Alternatively however, the at least one second service brake cylinder can continue to be kept in the applied state for safety reasons, even when the at least one spring-accumulator brake cylinder has already been applied.

The redundant parking brake function implemented in the controller can also be designed so that it actuates the second solenoid valve installation so as to release the at least one second service brake cylinder only when it can establish by means of the first sensor signal that the vehicle is at a standstill. As a result of this measure, the at least one second service brake cylinder is therefore released only once it has been ensured that the vehicle is actually at a standstill.

According to a further embodiment, the redundant parking brake function implemented in the controller can be designed so that it actuates the second solenoid valve installation at least for the duration, or only for the duration, so as to apply the at least one second service brake cylinder or keep the latter in an applied state, until it can establish by means of the first sensor signal that the vehicle is actually at a standstill.

At least one third sensor which directly or indirectly determines or measures the second service brake pressure prevalent in the at least one second service brake cylinder, and inputs a corresponding third sensor signal into the electronic controller, can also be provided in the brake system.

The redundant parking brake function implemented in the electronic controller can also be designed so that it actuates the second solenoid valve installation so as to increase a second service brake pressure in the at least one second service brake cylinder at least until the second service brake pressure has exceeded a minimum value. The minimum value for the second service brake pressure can be predetermined in such a manner that, by virtue of the minimum value, a holding force is exerted on the vehicle, which corresponds at least to the parking braking force exerted on the vehicle by the at least one applied spring-accumulator brake cylinder.

According to a refinement, the inlet/outlet solenoid valve combination in the parking brake installation can comprise an inlet solenoid valve and an outlet solenoid valve, wherein the inlet solenoid valve is connected to the at least one pressurized reservoir vessel, on the one hand, and to a pneumatic control input of a relay valve, on the other hand, and the outlet valve is connected to a pressure sink, on the one hand, and to the pneumatic control input of the relay valve, on the other hand, the working output thereof being connected to the at least one spring-accumulator brake cylinder, and the reservoir input thereof being connected to the at least one pressurized reservoir vessel.

The inlet/outlet solenoid valve combination of the parking brake installation can preferably comprise at least one 2/2-way valve and/or at least one 3/2-way valve which are/is monostable or bistable.

According to one preferred embodiment, the second solenoid valve installation can comprise at least one second inlet valve and at least one second outlet valve of a second pressure regulator module or of a second channel of a pressure regulator module. In this instance, the redundant parking brake function implemented in the electronic controller can be designed so that it controls the second inlet valve and the second outlet valve so as to increase or maintain the second service brake pressure in the at least one second service brake cylinder, so as to apply the at least one second service brake cylinder or keep the latter in an applied state.

Likewise preferably, the first solenoid valve installation can comprise at least one first inlet valve and at least one first outlet valve of a first pressure regulator module or of a first channel of a pressure regulator module, wherein the redundant parking brake function implemented in the electronic controller is designed so that it opens, or keeps open, the first inlet valve and the first outlet valve in a temporally overlapping manner, so as to apply the at least one spring-accumulator brake cylinder.

“Temporally overlapping” can mean that the point in time of opening at the first inlet valve and the first outlet valve is in each case identical, or else that the points in time of opening of the first inlet valve and of the first outlet valve are indeed different but there is a temporal interval during which the first inlet valve as well as the first outlet valve are open.

This ensures that compressed air is retrieved from the common pressurized reservoir vessel of the parking brake circuit and of the at least one service brake circuit by way of the opened first inlet valve, and as a result the first brake cylinder at the at least one first wheel is aerated. However, because the first outlet valve of the first solenoid valve installation is also opened, or open, simultaneously or temporally offset, the compressed air input into the first brake cylinder is vented into the pressure sink. As a result of this procedure of the temporally overlapping, and in particular simultaneous, aerating and venting of the at least one first service brake cylinder, the reservoir pressure in the common pressurized reservoir vessel drops, in particular at least to the application pressure of the at least one spring-accumulator brake cylinder.

As is known, such pressure regulator modules, apart from a backup valve for transmitting a redundant control pressure through the pressure regulator module, comprise a combination of an inlet valve and an outlet valve which then aerates or vents a relay valve with compressed control air, said relay valve at its working output being connected to at least one service brake cylinder, and at a reservoir input being connected to at least one pressurized reservoir vessel. Furthermore, such a pressure regulator module comprises a pressure sensor by way of which the outputted actual service brake pressure is determined and is feedback-controlled to a target service brake pressure in the context of a closed-loop brake pressure control. The target service brake pressure is represented by a target service brake pressure signal which, by way of an electronic service brake controller, is input into integrated control electronics of the pressure regulator module, which then correspondingly activates the inlet valve and the outlet valve. Consequently, in a 1-channel pressure regulator module, a brake pressure for one or a plurality of service brake cylinders is feedback-controlled, for example, and, in a 2-channel pressure regulator module, two brake pressures for at least two service brake cylinders are feedback-controlled. Therefore, two 1-channel pressure regulator modules are combined in terms of construction in one 2-channel pressure regulator module. In this instance, the brake system can be, for example, an EBS (electronically controlled brake system) with brake pressure feedback-control, which also comprises at least one driving dynamics control mechanism, such as ABS, ASR and/or ESP.

Also, the first inlet valve and/or the first outlet valve and/or the second inlet valve and/or the second outlet valve can be formed by a 2/2-way valve or a 3/2-way valve which are/is monostable or bistable. Monostable means that the valve is biased to a specific switching position and assumes s the latter when non-energized or de-energized. Bistable means that the valve maintains its last-assumed position, in particular switching position, when de-energized.

Alternatively or additionally, the second solenoid valve installation can comprise a holding valve and an outlet valve of an ABS pressure control valve. In this instance, the redundant parking brake function implemented in the controller can be designed so that it closes, or keeps closed, the holding valve and the outlet valve so as to maintain the service brake pressure in the at least one first service brake cylinder. Alternatively or additionally, the first solenoid valve installation can also comprise a holding valve and an outlet valve of such an ABS pressure control valve.

Such ABS pressure control valves typically contain two diaphragm valves which are controlled by solenoid valves, one solenoid valve representing a holding valve for maintaining pressure, and one solenoid valve representing an outlet valve for lowering pressure. When the holding valve is opened and the outlet valve is closed, the brake pressure input into the ABS pressure control valve is transmitted to a service brake cylinder. When the outlet valve is opened and the holding valve is closed, the service brake pressure in the service brake cylinder is reduced. By alternately opening and closing the holding valve and the outlet valve, the service brake pressure in the first service brake cylinder can then be feedback-controlled in the context of an anti-wheel lock control. In the context of the redundant parking brake controller, the outlet valve and the holding valve are closed so as to maintain the first service brake pressure in the first brake cylinder. Consequently, the ABS pressure control valve in this instance has an advantageous dual function in that it is controlled in the context of the anti-wheel lock control, on the one hand, and in the context of the redundant parking brake controller, on the other hand. The ABS pressure control valve can be disposed in a pressurized brake line between a pressure regulator module or a foot brake valve or a foot brake module.

The above examples, pressure regulator module and ABS pressure control valve, demonstrate that no additional valves are required for implementing the redundant parking brake function, and valve installations of the service brake installation that are typically already present can be utilized.

Also, the at least one electronic controller in which the redundant parking brake function is implemented can represent a single electronic controller in the context unit, of a separate structural or a stand-alone controller, or it can be distributed among a plurality of electronic controllers, or at least be partially integrated into a further electronic controller such as, preferably, into the electronic service brake controller. The redundant parking brake function is preferably implemented in an electronic controller which is different from the electronic parking brake controller.

As has already been explained above, two electro-magnetic service brake circuits can preferably be provided in the brake system, wherein the first solenoid valve installation and the second solenoid valve installation can be constituent parts of different electro-magnetic service brake circuits, or else of a single electro-magnetic service brake circuit.

The invention also relates to a vehicle, in particular a commercial vehicle equipped for operation with a trailer, which comprises a brake system described above.

Therefore, if the at least one spring-accumulator brake cylinder can no longer be applied by the parking brake control electronics and the inlet/outlet solenoid valve combination controlled by the latter (e.g. due to an electronic defect), the electronic controller is designed so that it applies the at least one spring-accumulator brake cylinder by venting at least one service brake circuit which comprises the at least one pressurized reservoir vessel that also supplies the parking brake circuit.

The venting herein preferably is performed by activating the at least one service brake circuit of the service brake installation by means of the electronic controller, for example in that at least one pressure regulator module is activated by the controller in such a manner that the service brake pressure, which is outputted by the at least one pressure regulator module and measured by the integrated pressure regulator module, for example, reaches or undershoots the application pressure of the at least one spring-accumulator brake cylinder. As a result, the at least one spring-accumulator brake cylinder is applied, and the vehicle can be parked in a safe state, even if the normal parking brake function no longer works. A further advantage lies in that no additional components for releasing purposes are required here.

The at least one pressure regulator module can be part of a primary or of a redundant service brake installation. The primary service brake installation is usually used, whereas the redundant service brake installation is used when the primary service brake installation has failed. Furthermore, the at least one pressure regulator module can be activated by a primary controller of the primary service brake installation or by a redundant controller of the redundant service brake installation. Also, the defect or fault in the parking brake circuit or in the parking brake function can be detected by the primary controller or by the redundant controller. The controller can be designed so that it detects the defect or fault in the parking brake circuit or in the parking brake function by means of sensor signals of at least one sensor, data bus signals, and/or due to an absent CAN communication, for example of the parking brake control electronics.

Also, at least one ABS pressure control valve can be controlled by the electronic controller in such a manner that the service brake pressure in at least one second service brake cylinder is maintained, so as to keep the vehicle at a standstill by the service brake installation, or by the second service brake circuit. In this instance, the at least one ABS pressure control valve can comprise the second solenoid valve installation in the context described above.

Also, the controller can activate at least one ABS pressure control valve in such a manner that the holding valve and the outlet valve open simultaneously or temporally overlapping, so as to vent the at least one pressurized reservoir vessel, which supplies the parking brake circuit also in this instance, preferably until the service brake pressure reaches at least the application pressure of the at least one spring-accumulator brake cylinder. The at least one ABS pressure control valve can in this instance comprise the second solenoid valve installation in the context described above.

The at least one ABS pressure control valve can be part of a primary or of a redundant service brake installation. The primary service brake installation is usually used, whereas the redundant service brake installation is used when the primary service brake installation has failed.

### DRAWING

An exemplary embodiment of the invention will be explained in more detail in the description hereunder with reference to the figures, in which:

FIG. 1 shows a brake system according to a preferred embodiment of the invention; and

FIG. 2 shows a fragment of a pressure regulator module and of a parking brake module of the brake system of FIG. 1.

### DESCRIPTION OF THE EXEMPLARY EMBODIMENT

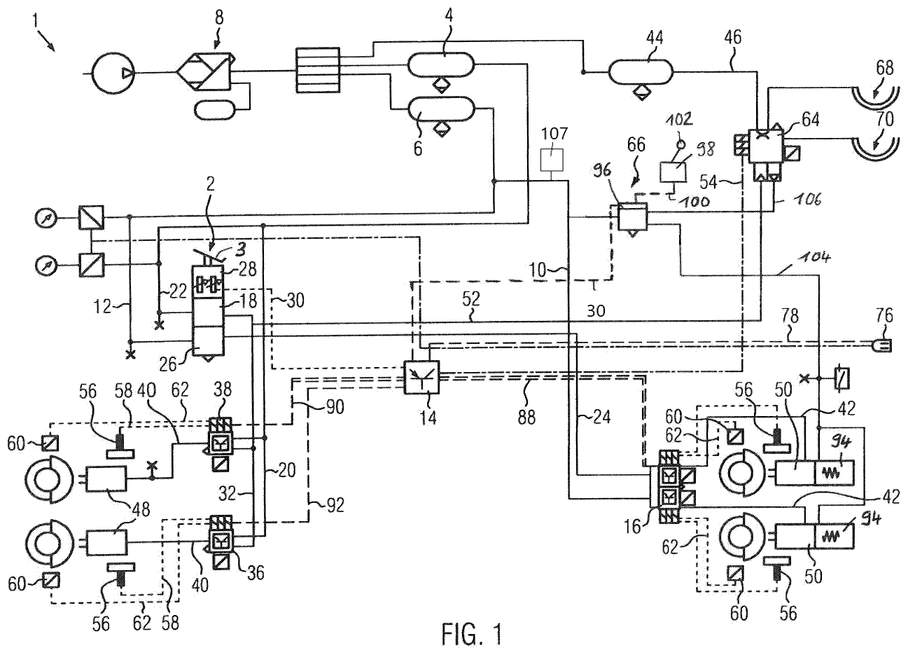

Schematically shown in FIG. 1 is a preferred embodiment of a brake system 1 of a tractor unit which is equipped for operation with a trailer and comprises an electro-pneumatic service brake installation, presently by way of example in the form of an electronic brake pressure feedback-controlled service brake system (EBS) and an electro-pneumatic parking brake installation. In the present case, the tractor unit is designed, for example, for towing a two-axle semitrailer not shown here; however, a drawbar trailer or a plurality of drawbar trailers may also be hauled by the tractor unit.

Provided in the electronically feedback-controlled brake system (EBS) are, for example, two 1-channel pressure regulator modules 36, 38 on a front axle, wherein a 1-channel pressure regulator module feedback-controls in each case the brake pressure in a pneumatic service brake cylinder 59 of a front wheel of the front axle, and a 2-channel pressure regulator module 16 in which two 1-channel pressure regulator modules are in principle combined, each channel feedback-controlling the brake pressure in a rear wheel of the rear axle. The construction and the function of such pressure regulator modules 16, 36, 38 is well known.

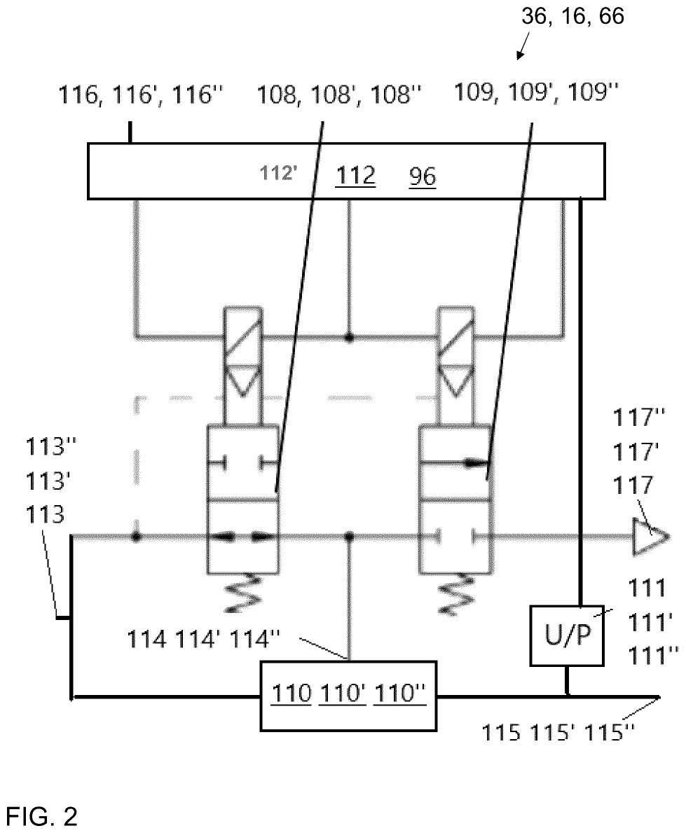

FIG. 2 illustrates the construction of a channel of the 2-channel pressure regulator module 16 on the rear axle, which is constructed in the manner described above and then, apart from a first backup valve not shown here, comprises a first inlet valve 108′, a first outlet valve 109′, a first relay valve 110′, a first pressure sensor 111′, first integrated control electronics 112′, a first reservoir connector 113′, a first working connector 115′ and a first signal connector 116′.

The first reservoir connector 113′ is connected to the rear-axle pressurized reservoir vessel 6 by way of the supply line 10, and the first working connector 115′ is connected to one of the two second service brake cylinders 50 on the rear axle on in each case one side of the vehicle. The further channel is constructed like the channel described above, whereby the first working connector 115′ is however connected to the other second service brake cylinder 50 on the other vehicle side of the rear axle. As a result, the service brake pressures can be feedback-controlled independently of one another in both channels.

The first relay valve 110′ modulates, from the reservoir pressure of the rear-axle pressurized reservoir vessel 6, prevalent at the first reservoir connector 113′, as a function of the first pneumatic control pressure formed by the first solenoid valves 108′, 109′, the first actual service brake pressure at the first working connector 115′. The first pressure sensor 111′ is likewise connected to the first working connector 115′, said first pressure sensor 111′ then measuring the first actual service brake pressure outputted by the respective channel of the 2-channel pressure regulator module 16 and inputting a corresponding sensor signal into the first control electronics 112′, the latter receiving a signal from a central EBS brake control apparatus 14 at the first signal connector 116′, said signal corresponding to a first target service brake pressure. Using feedback-control algorithms implemented in the integrated first control electronics 112′, the first actual service brake pressure is then adapted to the first target service brake pressure by correspondingly activating the first inlet valve 108′ and the first outlet valve 109′.

The construction of the 1-channel pressure regulator module 36, 38 on the front axle of FIG. 1 is likewise shown by way of example by means of FIG. 2, because it corresponds to the construction of one channel of the 2-channel pressure regulator module 16. Apart from a second backup valve not shown here, the 1-channel pressure regulator module 36 comprises a second inlet valve 108, a second outlet valve 109, a second relay valve 110, a second pressure sensor 111 and second integrated control electronics 112, which electrically control the second inlet valve 108, which is embodied as a 2/2-way solenoid valve, for example, and the second outlet valve 109, which is likewise embodied as a 2/2-way solenoid valve, for example. The second inlet valve 108 and the second outlet valve 109 each have a closed position and an opened position, wherein in FIG. 2 the second inlet valve 108 has been activated to the opened position and the second outlet valve 109 has been activated to the closed position.

On the input side, the second inlet valve 108 is connected to a second reservoir connector 113 of the 1-channel pressure regulator module 36, said reservoir connector 113 being connected to a front-axle pressurized reservoir vessel 4 by way of a supply line 20, and on the output side is connected to a second pneumatic control connector 114 of the second relay valve 110, the latter on the input side being connected to the second reservoir connector 113 and on the output side to a second working connector 115 of the 1-channel pressure regulator module 36. On the input side, the second outlet valve 109 is connected to the second pneumatic control connector 114 of the second relay valve 110, and on the output side to a second pressure sink 117.

In the process, the secondary relay valve 110 modulates, from the reservoir pressure of the front-axle pressurized reservoir vessel 4 prevalent at the second reservoir connector 113, the actual service brake pressure at the second working connector 115 as a function of the second control pressure formed by the second solenoid valves 108, 109. The second pressure sensor 111 is likewise connected to the second working connector 115, said second pressure sensor 111 then measuring the actual service brake pressure outputted by the 1-channel pressure regulator module 36 and inputting a corresponding sensor signal into the second control electronics 112, the latter at a second signal connector 116 receiving a signal, which corresponds to a second target service brake pressure, from a central EBS brake control apparatus 14. The second actual service brake pressure is then adapted to the second target service brake pressure by correspondingly activating the second inlet valve 108 and the second outlet valve 109 using feedback-control algorithms implemented in the integrated second control electronics 112.

Should this predominant electronic controller of the pressure regulator modules 16, 36 and/or 38 fail, the now non-energized integrated backup valve switches in each case and the respective pneumatic control input 114, 114′ of the respective relay valve 110, 110′ is controlled by the respective pneumatic control pressure routed in the control lines 24, 34, said control pressure being that of the front-axle or rear-axle brake circuit which in this instance is purely pneumatic.

The electronically feedback-controlled brake system (EBS) of the tractor unit furthermore contains an anti-wheel lock control (ABS), the ABS control routines thereof preferably being integrated into the central electronic EBS brake control apparatus 14. Furthermore present here in the electronically feedback-controlled brake system (EBS) are preferably a traction slip control (ASR) and an electronic stability program (ESP), wherein the respective control routines are preferably likewise implemented in the central brake control apparatus 14.

Present according to the circuit diagram of the electro-pneumatic brake installation 1 of the tractor unit shown in FIG. 1 are a foot brake valuator or foot brake module 2, here having a foot brake pedal as a service brake activation element 3, the front-axle pressurized reservoir vessel 4 for supplying a front-axle service brake circuit, and a rear-axle pressurized reservoir vessel 6 for supplying a rear-axle service brake circuit and at the same time a parking brake circuit. Here for example, the rear-axle pressurized reservoir vessel 6 alone represents a common pressurized reservoir vessel for the rear-axle service brake circuit and the parking brake circuit in this instance. The air intake, air preparation and safeguarding is embodied as per the statutory requirements, presently by an air preparation module 8 not described here in more detail.

The rear-axle pressurized reservoir vessel 6, by way of pneumatic supply lines 10, 12, is connected to the two first reservoir connectors 113′ of the 2-channel pressure regulator module 16 for the first service brake cylinders 50 of the rear axle, on the one hand, and to a rear-axle channel 26 of the foot brake module 2. In an analogous manner, the front-axle pressurized reservoir vessel 4, by way of pneumatic supply lines 20, 22, is connected to the second reservoir connectors 113 of the two 1-channel pressure regulator modules 36, 38, which are in each case assigned to one second service brake cylinder 48 of a front wheel, and to a front-axle channel 18 of the foot brake module 2.

The foot brake module 2 therefore comprises two pneumatic channels 18, 26 which in each case generate a pneumatic backup pressure or control pressure at the outputs of the channels 18, 26 as a function of a braking requirement predefined by the foot of the driver acting on the foot brake pedal 3. Parallel thereto, an electrical front-axle channel and an electrical rear-axle channel are configured so as to be combined in an electrical channel 28 in the foot brake module 2, said axles in each case inputting an electrical braking requirement signal, as a function of the braking requirement, into an electrical connection, preferably formed as a data bus 30, between the electrical channel 28 of the foot brake module 2 and the central electronic EBS brake control apparatus 14, which is able to differentiate the two braking requirement signals for the front axle and the rear axle, which differ because of the load distribution, for example.

Furthermore, the front-axle channel 18 and the rear-axle channel 26 of the foot brake module 2 are in each case connected by way of the pneumatic control lines 24, 32 to assigned backup connectors, not shown here, of the 2-channel pressure regulator module 16, or of the 1-channel pressure regulator modules 36, 38. Furthermore, a first and a second pneumatic brake line 40, 42 lead in each case from the two first working connectors 115′ of the 2-channel pressure regulator module 16, or from the two second working connectors 115 of the two 1-channel pressure regulator modules 36, 38, to the wheel-specific pneumatic first and second service brake cylinders 48, 50 of the front axle, or of the rear axle, respectively.

Rotating speed sensors 56 report the wheel rotating speed of the wheels of the two-axle vehicle to the central brake control apparatus 14 by way of electrical signal lines 58. Wear sensors 60 are likewise preferably provided for each wheel brake, and send signals to the central brake control apparatus 14 by way of electrical signal lines 62 as a function of the current brake wear.

Furthermore provided is a trailer control module 64 which, by way of a supply line 46, is supplied with compressed air from a trailer pressurized reservoir vessel 44 on the tractor unit, on the one hand, and, by way of a control line 52, is pneumatically controlled by backup pressure, for example by the pneumatic control pressure of the front-axle channel 18 of the foot brake module 2, on the other hand. Furthermore, the trailer control module 64 also receives an electrical signal from the central brake control apparatus 14 by way of an electrical control line 54. Finally, the trailer control module 64 is pneumatically actuated by a parking brake module 66 of the parking brake circuit.

Apart from a backup solenoid valve for redundant pressure control analogous to that of the 1-channel pressure regulator module 36 of FIG. 2, the trailer control module 64 likewise contains an inlet valve, an outlet valve and a relay valve which is supplied with compressed air by the trailer pressurized reservoir vessel 44, so as to output a control pressure for a coupling head “brake” 70 by way of these solenoid valves and the relay valve, as a function of a control signal provided by way of the electrical control line 54. The relay valve here modulates, from the reservoir pressure of the trailer pressurized reservoir vessel 44 prevalent at the reservoir connector of said relay valve, the control pressure for the coupling head “brake” 70 as a function of the control pressure formed by the solenoid valves. This control pressure for the coupling head “brake” 70 is measured by means of an integrated pressure sensor and reported to the central brake control apparatus 14. Should this predominant electrical control fail, the integrated backup valve switches and the relay valve is controlled by the pneumatic control pressure of the front-axle brake circuit routed in the control line 52. Finally, the trailer control module 64 transmits the compressed air emanating from the trailer pressurized reservoir vessel 44 at a reservoir pressure to a coupling head “reservoir” 68 of the tractor unit. The construction and the functions of such an electro-pneumatic trailer control module 64 are well known and therefore do not need to be explained in further detail here.

The brake application installations of the rear axle are preferably designed as known combination cylinders, i.e. as a combination of an active second service brake cylinder 50 and a passive spring-accumulator brake cylinder 94 (combination cylinder). “Active” in this context means that the second service brake cylinders 50 are applied when aerated, and released when vented, and “passive” means that the spring-accumulator brake cylinders 94 are applied when vented, and released when aerated. In contrast, only active first service brake cylinders 48 are provided on the wheels of the front axle. In contrast, the spring-accumulator brake cylinders 94 are passive brake cylinders and are released by aerating and applied by venting.

The electro-pneumatic 2-channel pressure regulator module 16, which is embodied as a functional unit, on the rear axle has two separately feedback-controllable pressure regulator channels, wherein a feedback-controlled working pressure for the second brake cylinders 50 of the rear axle is generated for each pressure regulator channel based on reservoir air emanating from the rear-axle pressurized reservoir vessel 6, as a function of the service braking requirement signal generated in the electrical channel 28 of the foot brake module 2 and modified according to requirements in the central brake control apparatus, said working pressure being measured by means of the integrated first pressure sensors 111′ (FIG. 2) so as to adapt or adjust the measured first actual brake pressure to the first target brake pressure according to the service braking requirement signal. In analogous manner, the second brake pressure is feedback-controlled individually in each 1-channel pressure regulator module 36, 38 of the front axle for the two first service brake cylinders 48 of the wheels of the front axle.

For forming pneumatically separated pressure regulator channels per circuit (for example presently the front-axle pressure regulator channel, or the rear-axle pressure regulator channel), each pressure regulator channel is consequently assigned a dedicated pressurized reservoir vessel 4, 6, wherein the pneumatic flow paths of each pressure regulator channel, proceeding from the assigned pressurized reservoir vessel 4, 6, by way of the assigned pressure regulator modules 16, 36, 38, to the assigned first and second service brake cylinders 48, 50, are formed so as to be pneumatically separate from the pneumatic flow path of a respective other pressure regulator channel.

For forming an electro-pneumatic service brake installation having predominantly electrically activated pressure regulator channels (front-axle pressure regulator channel, or rear-axle pressure regulator channel) and a secondary pneumatic fallback plane in the event of a failure of the electric system, each pressure regulator module 16, 36, 38 is particularly preferably assigned a dedicated purely pneumatic backup circuit, having a dedicated backup valve for inputting a pneumatic backup pressure which is derived from the reservoir pressure of the pressurized reservoir vessel 4, 6 that is assigned to the respective pressure regulator circuit of the rear axle, or the front axle, and formed by the foot brake module 2, from which backup pressure the respective brake pressure is formed at the first and the second working connectors 115′, 115 (FIG. 2) of the pressure regulator modules 16, 36, 38 in the event of a failure of electrical components.

The brake installation 1 of the tractor unit and the brake installation of the trailer are in each case coupled to one another by means of one coupling head “reservoir” 68 and in each case by means of a coupling head “brake” 70, as is usual in such brake systems. Because the trailer control module 64 does not have a dedicated electronic control apparatus, the electrical brake control signals have to be transmitted from the central brake control apparatus 14 by way of a CAN-BUS “trailer” 78 and an electronic trailer interface 76 to the trailer, should the latter have an electro-pneumatic brake system. The trailer control module 64, like the 2-channel pressure regulator module 16 and the two 1-channel pressure regulator modules 36, 38, are in each case activated by the central brake control apparatus 14 by way of an electrical control line 54, 88, 90, 92.

Instead of a purely pneumatic brake system, the trailer could also be provided with an electro-pneumatic brake system with ABS function. In this case, the electrical interface 76 of the tractor unit is connected to a complementary interface in the trailer by way of a data connection, for example a cable, said complementary interface leading to an ABS control apparatus in the trailer, so as to be able to exchange data. In this way, anti-wheel lock control is carried out for all axles of the trailer. However, when the wheel brake slippage detection is carried out by wheel rotating speed sensors on, for example, only one axle of the 2-axle semitrailer, as is preferred, the brake slippage on the other axle, not provided with wheel rotating speed sensors, is feedback-controlled according to the one axle with wheel rotating speed sensors. This may result in the disadvantages, described at the outset, in terms of the blocking of the brakes of the other axle without wheel rotating speed sensing, and the associated deficient lateral guidance of the wheels on this other axle.

The parking brake module 66 is at least partially of the same construction as the pressure regulator module 36 of FIG. 2, and contains integrated parking brake control electronics 96 which receive parking braking requirement signals from an electric parking brake activation installation 98, said signals being inputted into the parking brake module 66 by way of an electrical control line 100 via a third signal connector 116′. The parking braking requirement signals here are electrically generated as a function of an activation of a parking brake activation element 102. This parking brake activation element 102 is typically a lever, a rocker switch or a pushbutton and is usually manually activated by the driver. The parking brake control electronics 96 communicate with the central EBS brake control apparatus 14 by way of the data bus 30. Apart from the parking brake control electronics 96, a third inlet valve 108′″, a third outlet valve 109′″, a third relay valve 110′″ pneumatically controlled by the latter at a third control connector 114″, and a third pressure sensor 111′″, are furthermore integrated into the parking brake module 66. A third working connector 115′″ of the parking brake module 66 is in this instance connected to the spring-accumulator brake cylinders 94 of the rear axle by way of a pneumatic line 104. A further, third working connector, not shown in FIG. 2, of the parking brake module 66 pneumatically controls the trailer control module 64 by way of a further pneumatic line 106. The parking brake circuit does not have a dedicated pressurized reservoir vessel, so that the parking brake module 66 is supplied with reservoir pressure by way of a third reservoir connector 113″ and the supply line 10, here from the rear-axle pressurized reservoir vessel 6, for example. The construction of the parking brake module 6 such as shown in FIG. 2 is purely exemplary. Additionally, the parking brake module 66 can have further valves or solenoid valves so as to carry out further functions such as, for instance, a test function or an auxiliary brake function. At least one integrated proportional valve and/or at least one holding valve can also be provided in the parking brake module 66.

The third inlet valve 108″ is a “normally open” valve, i.e. when non-energized switches to the open position due to being biased by a spring, while the third outlet valve 109′″ is a “normally closed” valve, i.e. when non-energized switches to the closed position due to being biased by a spring. This has the effect that when for example the entire parking brake module 66 is de-energized in the event of a fault in the activation by the integrated parking brake control electronics 96, the spring-accumulator brake cylinders 94 are connected to the rear-axle reservoir vessel 6 by way of the open third inlet valve 108″ and are thus aerated. It is prevented as a result that the spring-accumulator brake cylinders 94 are abruptly vented, for example in the event of a power failure or a malfunction during travel of the vehicle, this creating a critical situation with a view to the driving stability.

A parking brake function for normal operation is implemented by software in the parking brake control electronics 96, and, moreover, a redundant parking brake function is implemented by software in the central brake control apparatus 14, for example, wherein the parking brake function for normal operation and the redundant parking brake function will be described further below.

Furthermore connected to the supply line 10, by way of which the third reservoir connector 113″ of the parking brake module 66 is supplied with compressed air from the rear-axle pressurized reservoir vessel 6, is a pressure sensor 107 which measures the pressure in the rear-axle pressurized reservoir vessel 6 and inputs a corresponding reservoir pressure signal, presently into the central brake control apparatus 14, for example, so as to use said signal in the context of the redundant parking brake function implemented therein, for example.

The front-axle pressurized reservoir vessel 4 supplies a front-axle service brake circuit which comprises at least the two pressure regulator modules 36, 38 and the two second service brake cylinders 48 on the front axle, and the rear-axle pressurized reservoir vessel 6 supplies a rear-axle service brake circuit which comprises at least the 2-channel pressure regulator module 16 and the two first service brake cylinders 50 on the rear axle. Due to separate circuits, the front-axle pressurized reservoir vessel 4 is independent of the rear-axle pressurized reservoir vessel 6, the latter presently forming the common pressurized reservoir vessel for the parking brake circuit and the rear-axle service brake circuit, for example.

Against this background, the functioning of the brake installation 1 is as follows:

In a normal service brake procedure, the driver actuates the brake pedal and thus the foot brake module 2, as a result of which an electrical braking requirement signal, which is analogous to the desired target deceleration, or to the driver's braking request, is generated in the electrical channel 28 and inputted into the central brake control apparatus 14, the latter subsequently inputting in each case a target brake pressure into the trailer control module 64, the 2-channel pressure regulator module 16 of the rear axle and the two 1-channel pressure regulator modules 36, 38 of the front axle by way of the electrical control lines 54, 88, 90, 92, said target brake pressure corresponding to the brake requirement signal and potentially being a function of further parameters such as the respective load distribution.

In the process, the first and second inlet valves 108, 108′ and outlet valves 109, 109′ which are in each case integrated into the pressure regulator modules 16, 36, 38 as well as in the trailer control module 64 and are presently designed in each case as 2/2-way solenoid valves, are switched according to the braking requirement so that said valves pneumatically control the first and second relay valves 110, 110′ which are likewise integrated, so as to input actual service brake pressures, corresponding to the braking requirement, into the respective first and second service brake cylinders 48, 50 of the tractor unit, or into the brake cylinders of the trailer by way of the coupling head “brake” 70. The first and second pressure sensors 111, 111′ (FIG. 2) integrated into the pressure regulator modules 16, 36 and 38, and also the pressure sensor integrated into the trailer control module 64, then report the actual service brake pressure to the integrated first and second control electronics 112, 112′ in the pressure regulator modules 16, 36 and 38, or to the integrated control electronics in the trailer control module 64, said control electronics thereupon adjusting the respective target brake pressure by activating the integrated solenoid valves.

If the brake requirement signal for the central brake control apparatus 14 is generated by a driver assistance system such as, e.g., ESP (electronic stability program) or ACC (adaptive cruise control) or by an autopilot for autonomous driving instead of the foot brake module 2, the same functions as described above are carried out.

If the brake slippage of a wheel or of a plurality of wheels of the tractor unit exceeds a predefined brake slippage limit of, for example, 12% to 14%, which can be established by way of the wheel rotating speed sensors 56, the anti-wheel lock control, or the ABS, of the tractor unit responds. In the process, the brake pressures for the tractor unit are adjusted by the ABS routines implemented in the central EBS brake control apparatus 14 by way of correspondingly activating the integrated first and second inlet and outlet valves 108, 108′, 109, 109′ in the 1-channel pressure regulator module 36, 38 assigned to the respective wheel with brake slippage, or in the 2-channel pressure regulator module 16 assigned to the respective wheels with brake slippage, in such a way that the brake slippage feedback-control difference is adjusted.

Compatibility bands which establish the ratio between the respectively desired deceleration z of the tractor unit-trailer combination and the resultant braking force of the trailer, and the pressure at the coupling head “brake” 70 of the tractor unit are stored in the central EBS brake control apparatus 14. The brake pressure for the brake system of the trailer, which is derived from the compatibility band, can then be optionally also modified by a coupling force feedback-control. In this instance, the trailer control module 64 is actuated by the central brake control apparatus 14 so as to set the pneumatic control pressure in the coupling head “brake” 70 for the trailer according to these parameters. In this way, the brake pressure in the trailer would be formed as a function of the brake pressure in the tractor unit which is influenced by the anti-wheel lock control.

In summary, therefore, the brake pressure of the brake system of the trailer, which in terms of its absolute magnitude is a function of the brake requirement signal or of the predefined target deceleration of the tractor unit-trailer combination, of the responding anti-wheel lock control (coefficient of friction of the road surface) of the tractor unit, of the compatibility band of the tractor unit-trailer, and potentially also of a coupling force feedback-control, then forms a reference brake pressure for the brake system of the trailer. Instead of a reference brake pressure, a reference braking force of the trailer, or a reference deceleration of the trailer, may also be utilized, which relates to the same circumstances described above.

If, after decelerating the vehicle to a standstill by means of the service brake installation, the parking brake activation element 102 in the context of the parking brake function in normal operation is moved to the position “parking”, a corresponding electrical parking brake application signal is inputted into the parking brake control electronics 96 by way of the third signal connector 116″, said parking brake control electronics 96 thereupon controlling the integrated inlet/outlet solenoid valve combination, specifically the third inlet valve 108″ and the third outlet valve 109″ (the third inlet valve 108″ to the closed position, the third outlet valve 109″ to the open position, as in FIG. 2), so as to vent the third working connector 115″ and thus the pneumatic line 104 and the spring-accumulator brake cylinders 94, the latter thereupon being applied. The other, third working connector, which is connected to the pneumatic line 106, is likewise vented. Consequently, the pneumatic control connector of the trailer control module 64, which is connected to the pneumatic line 106, is likewise vented, wherein the trailer control module 66 according to its inverting characteristic then aerates the coupling head “brake” 70 in order to apply the trailer brakes.

For releasing the parking brake, the parking brake activation element 102 is activated to the position “driving”, so as to input a corresponding parking brake release signal into the integrated parking brake control electronics 96 by way of the third signal connector 116″, said parking brake control electronics 96 thereupon controlling the third inlet valve 108″ and the third outlet valve 109″ so as to vent the third working connector 115″ and thus the pneumatic line 104 and the spring-accumulator brake cylinders 94 (the third inlet valve 108″ to the open position, the third outlet valve 109″ to the closed position, as in FIG. 2), said spring-accumulator brake cylinders 94 thereupon being released. The other, third working connector which is connected to the pneumatic line 106 is likewise vented. In the process, the pneumatic control connector of the trailer control module 64, which is connected to the pneumatic line 106, is likewise vented, wherein the trailer control module 66 according to its inverting characteristic then vents the coupling head “brake” 70 in order to release the trailer brakes.

Moreover, even further functions such as, for example, a test function can be implemented in the parking brake module 66, by way of which test function it is tested whether the tractor unit with the applied parking brake can hold the unbraked trailer at a standstill, or else an auxiliary brake function in which the parking brake supports the service brake or replaces the latter in a redundant manner. For this purpose, the parking brake activation element 102 has a plurality of infinitely adjustable positions for the degree of auxiliary braking, and a position for the test function.

For example, the parking brake control electronics 96 integrated into the parking brake module 66 is externally monitored by the central brake control apparatus 14 as to whether at least the parking brake function “apply parking brake” functions flawlessly in normal operation. This external monitoring here is performed by way of the data bus 30, for example, to which the third signal connector 116″ of the parking brake module 66 as well as the central brake control apparatus 14 are connected.

If it has been established here, for example by the central brake control apparatus 14, that the parking brake module 66 is unable to perform at least the parking brake function “apply parking brake”, whether because the parking brake controller 96, a current supply of the parking brake module 66, a signal connection within the parking brake module 66 and/or the third inlet valve 108″ and/or the third outlet valve 109″ have/has a fault or a defect, the redundant parking brake function comes to bear, by way of which the parking brake function “apply parking brake” can then be carried out in a redundant manner, so that the tractor unit and optionally the trailer coupled to the latter can be decelerated and/or securely held at a standstill.

It is assumed here that the third inlet valve 108″ as well as the third outlet valve 109″ are de-energized due to a fault or defect. Because the third inlet valve 108″ is a “normally open” valve, as described above, i.e. when non-energized switches to the open position due to being biased by the spring, and the third outlet valve 109″ is a “normally closed” valve, i.e. when non-energized switches to the closed position due to being biased by the spring, the spring-accumulator brake cylinders 94 are automatically connected to the rear-axle pressurized reservoir vessel.

The redundant parking brake function is implemented as software, for example in the central brake control apparatus 14, wherein in order then to achieve independence between the central brake control apparatus 14 and the parking brake control electronics 96, the central brake control apparatus 14 is preferably supplied with an electric current by a second voltage supply which is independent in terms of a first voltage supply of the parking brake control electronics 96.

In the context of the redundant parking brake function, the central brake control apparatus 14, for example, optionally actuates the two 1-channel pressure regulator modules 36, 38 on the front axle, so that the second service brake cylinders 48 on the front axle are applied and then decelerate the tractor unit, optionally conjointly with the trailer coupled thereto, or keep said tractor unit at a standstill. For this purpose, the second inlet valve 108 is switched to the open position, and the second outlet valve 109 is switched to the closed position, so that compressed air from the front-axle pressurized reservoir vessel 4 can flow into the second service brake cylinders 48 on the front axle. This control of the two 1-channel pressure regulator modules 36, 38 on the front axle is optional and may also be dispensed with.

Preferably simultaneously with, or after, the optional control of the two 1-channel pressure regulator modules 36, 38 on the front axle, as described above, the central brake control apparatus 14 actuates the 2-channel pressure regulator module 16 on the rear axle in such a manner that, for example, the first inlet valve 108′ as well as the first outlet valve 109′ open in each of the two channels. This has the consequential effect that compressed air from the rear-axle pressurized reservoir vessel 6 flows into the first service brake cylinders 50 on the rear wheels, but from there flows outward by way of the opened first outlet valves 109′ into the first pressure sinks 117. The open switching position of the first outlet valves 109′ and of the first inlet valves 108′ of the 2-channel pressure regulator module 16 is maintained the context of the redundant parking brake function, in particular by the central brake control apparatus 14, until the reservoir pressure prevalent in the rear-axle pressurized reservoir vessel 6 has dropped to an application pressure of the spring-accumulator brake cylinders 94 on the rear axle, the spring-accumulator brake cylinders 94 being applied as a result. Because the reservoir pressure prevalent in the rear-axle pressurized reservoir vessel 6 is preferably measured by the pressure sensor 107 and is inputted into the central brake control apparatus 14 as a corresponding reservoir pressure signal, a value for the application pressure of the spring-accumulator brake cylinders 94, which is determined by tests, for example, and is then compared with the current actual value of the reservoir pressure supplied by the pressure sensor 107, can then be stored in a memory of the central brake control apparatus 14.

Therefore, the open position of the first inlet valves 108′ as well as of the first outlet valves 109′ of the 2-channel pressure regulator module 16 therefore ensure that the rear-axle compressed air reservoir 6, which supplies the rear-axle service brake circuit as well as the parking brake circuit with compressed air, is vented over time.

The venting of the rear-axle compressed air reservoir 6, to which the parking brake module 66 is indeed likewise connected, then also ensures that the other, third working connector of the parking brake module 66, which is connected to the pneumatic line 106, is likewise vented. Consequently, the pneumatic control connector of the trailer control module 64, which is connected to the pneumatic line 106, is likewise vented, wherein the trailer control module 66 according to its inverting characteristic then vents the coupling head “brake” 70 in order to apply the trailer brakes.

Topping up of compressed air into the rear-axle pressurized reservoir vessel 6 by a compressor of the brake system 1 driven by a drive machine is preferably prevented in that the central brake control apparatus 14 here is designed, for example, so that it activates, puts into operation or carries out the redundant parking brake function only when an ignition switch of the drive machine is switched off.

The applied spring-accumulator brake cylinders 94 of the tractor unit, and the applied brake cylinders of the optionally coupled trailer, then generates a sufficient holding force, as in the normal case of the parking brake function, so that the tractor unit, optionally with the trailer coupled to the latter, is kept at a standstill.

However, venting the rear-axle pressurized reservoir vessel 6 not only performs an application of the spring-accumulator brake cylinders 94 of the tractor unit and optionally of the brake cylinders of the trailer, but also venting of the first service brake cylinders 50 on the rear axle, should the first outlet valves 109′ of the 2-channel pressure regulator module 16 continue to be switched to the open position. The braking effect exerted by the first service brake cylinders 50 on the rear axle then decreases, this however not leading to any compromise in terms of safety, because the required holding force is exerted by the applied spring-accumulator brake cylinders 96 in the context of the redundant parking brake function.

In this instance, it is furthermore preferably also no longer necessary to keep the second service brake cylinders 48 on the front axle applied, so that the central brake control apparatus 14 in the context of the redundant parking brake function closes in each case the second inlet valves 108 and opens the second outlet valves 109 in the two 1-channel pressure regulator modules 36, 38 on the front wheels, so as to release the second service brake cylinders 48 on the front axle. This measure can preferably also be carried out only when the central brake control apparatus 14 in the context of the redundant parking brake function has established by means of the wheel rotating speed signals inputted by the rotating speed sensors 56 that the tractor unit, optionally with a trailer coupled to the latter, is at a standstill.

It can furthermore be provided in the context of the redundant parking brake function that the second pressure sensors 111, which are integrated into the 1-channel pressure regulator modules 36, 38, measure the service brake pressures prevalent in the (initially still) applied second service brake cylinders 48 of the front wheels, and input corresponding service brake pressure sensor signals into the central brake control apparatus 14. The central brake controller 14 can then, for example, open, or keep open, the second inlet valves 108 of the 1-channel pressure regulator modules 36, 38 on the front axle, and close, or keep closed, the second outlet valves 109, until it can establish by means of the service brake pressure sensor signal that the service brake pressures inputted into the second service brake cylinders 48 of the front wheels have in each case exceeded a minimum value. The minimum value for the service brake pressure here can in each case be predetermined in such a manner that, due to the minimum value for the service brake pressure, a holding force is exerted on the tractor unit and on the trailer optionally coupled to the latter, which corresponds at least to the parking braking force which is exerted by the applied spring-accumulator brake cylinders 94 and optionally the applied brake cylinders of the trailer.

Additionally or alternatively to the pressure regulator modules 16, 36 and 38, the brake system 1 can comprise at least one ABS pressure control valve, not shown here, such as is usually used for an anti-wheel lock control (ABS). Such ABS pressure control valves typically contain two diaphragm valves which are controlled by solenoid valves, of which one solenoid valve represents a holding valve for maintaining pressure, and one solenoid valve represents an outlet valve for lowering pressure. When the holding valve is opened and the outlet valve is closed, the brake pressure inputted into the ABS pressure control valve is transmitted to a service brake cylinder. However, when the outlet valve is opened and the holding valve is closed, the service brake pressure in the service brake cylinder is reduced. By alternately opening and closing the holding valve and the outlet valve, the service brake pressure in the service brake cylinder is then feedback-controlled in the context of an anti-wheel lock control. In this instance, one such ABS pressure control valve can in each case be disposed in the brake lines 40 on the front axle and/or in the brake lines 42 on the rear axle, so as to carry out a wheel-specific ABS control.

In the context of the redundant parking brake function, the ABS pressure control valves can then be activated here by the central brake control apparatus 14 in such a manner, for example, that when the service brake installation has already been activated by the driver or automatically, the holding valve and the outlet valve, presently on the ABS pressure control valves on the front axle, for example, are closed so that the first service brake pressure in the second service brake cylinders 48 of the front axle is maintained, and the second service brake cylinders 48 remain applied.

The above examples—pressure regulator module and ABS pressure control valve—demonstrate that no additional valves are required for implementing the redundant parking brake function, and valves of the service brake installation which are typically already present can be utilized.

The controller in which the redundant parking brake function is implemented can also represent a stand-alone controller, or can be distributed among a plurality of controllers, or be at least partially integrated into a further controller such as presently into the central brake control apparatus 14, for example. The redundant parking brake function is preferably implemented in a controller which is different from the electronic parking brake control electronics 96.

### LIST OF REFERENCE SIGNS

1 Brake system
2 Foot brake module
3 Service brake activation element
4 FA pressurized reservoir vessel
6 RA pressurized reservoir vessel
8 Air preparation module
10 Supply line
12 Supply line
14 Central brake control apparatus
16 2-channel pressure regulator module
18 FA channel
20 Supply line
22 Supply line
24 Control line
26 RA channel
28 Electrical channel
30 Data bus
32 Control line
36 First pressure regulator module
38 First pressure regulator module
40 Pneumatic brake line
42 Pneumatic brake line
44 Trailer pressurized reservoir vessel
46 Supply line
48 First service brake cylinders
50 Second service brake cylinders
52 Control line
54 Electrical control line
56 Rotating speed sensors
58 Electrical signal lines
60 Wear sensors
62 Electrical signal lines
64 Trailer control module
66 Parking brake module
68 Coupling head “reservoir”
70 Coupling head “brake”
76 Trailer interface
78 Trailer data bus
88 Electrical control line
90 Electrical control line
92 Electrical control line
94 Spring-accumulator brake cylinder
96 Parking brake control electronics
98 Parking brake activation installation
100 Electrical control line
102 Parking brake activation element
104 Pneumatic line
106 Pneumatic line
107 Pressure sensor
108, 108′, 108″ First, second, third inlet valve
109, 109′, 109″ First, second, third outlet valve
110, 110′, 110″ First, second, third relay valve
111, 111′, 111″ First, second, third pressure sensor
112, 112′ First, second control electronics
113, 113′, 113″ First, second, third reservoir connector
114, 114′, 114″ First, second, third control connector
115, 115′, 115′″ First, second, third working connector
116, 116′, 116″ First, second, third signal connector
117, 117′, 117″ First, second, third pressure sink

1. A brake system of for a vehicle, comprising:
an electro-pneumatic parking brake installation with a parking brake function;
an electro-pneumatic service brake installation with at least one electro-pneumatic service brake circuit; and
a redundant parking brake function which is implemented in at least one controller and is configured to operate when the parking brake function has failed, wherein a holding force for holding the vehicle at a standstill is in each case able to be generated with aid of the parking brake function and the redundant parking brake function; wherein
a) the electro-pneumatic service brake installation comprises at least one first service brake cylinder assigned to a first wheel of the vehicle, at least one electronic service brake controller, at least one pressurized reservoir vessel and a first solenoid valve installation which is able to be controlled by the at least one electronic service brake controller and by the redundant parking brake function; wherein
b) the first solenoid valve installation is configured so that compressed air from the at least one pressurized reservoir vessel can be directed into the at least one first service brake cylinder, and simultaneously, or temporally overlapping, compressed air from the at least one first service brake cylinder can be directed into a pressure sink; and
c) the parking brake installation includes an electro-pneumatic parking brake circuit which is supplied with compressed air exclusively by the at least one pressurized reservoir vessel and has at least one pneumatically controlled spring-accumulator brake cylinder, an electronic parking brake controller and an inlet/outlet solenoid valve combination, which is controlled by the electronic parking brake controller, for at least aerating and venting the at least one spring-accumulator brake cylinder, and is designed in such a manner that, in a non-energized state, it connects the at least one spring-accumulator brake cylinder to the at least one pressurized reservoir vessel; and
d) the redundant parking brake function is configured so that, upon recognizing a fault or a defect in the parking brake circuit that causes the non-energized state of the inlet/outlet solenoid valve combination, it actuates the first solenoid valve installation in a pressure reduction mode so as to direct compressed air from the at least one pressurized reservoir vessel into the first service brake cylinder and simultaneously, or temporally overlapping, to direct compressed air from the first service brake cylinder into the pressure sink.

2. The brake system of claim 1, further comprising:
a first sensor configured to detect whether the vehicle is at a standstill and the first sensor inputs a first sensor signal, representing the standstill of the vehicle, into the at least one controller for evaluation by the redundant parking brake function,
wherein the redundant parking brake function is configured so that it actuates the first solenoid valve installation in the pressure reduction mode when it additionally recognizes the standstill of the vehicle by means of the first sensor signal.

3. The brake system of claim 1, further comprising:
a second sensor which determines or measures a reservoir pressure prevalent in the at least one pressurized reservoir vessel and inputs a corresponding reservoir pressure signal for evaluation by the redundant parking brake function into the at least one controller.

4. The brake system of claim 3, wherein the redundant parking brake function is configured so that it actuates the first solenoid valve installation at least for a duration so as to direct compressed air from the at least one pressurized reservoir vessel into a second service brake cylinder and simultaneously, or temporally overlapping, to direct compressed air from the second service brake cylinder into the pressure sink, until said redundant parking brake function can establish that the reservoir pressure in the at least one pressurized reservoir vessel has dropped to a pressure lower than or equal to an application pressure of the at least one spring-accumulator brake cylinder.

5. The brake system of claim 1, wherein the electro-pneumatic service brake installation comprises at least one second service brake cylinder assigned to a second wheel of the vehicle, and a second solenoid valve installation which is controlled by the at least one electronic service brake controller, wherein the second solenoid valve installation is configured so that a second service brake pressure in the at least one second service brake cylinder can be maintained, increased or lowered with the aid of the second solenoid valve installation.

6. The brake system of claim 5, wherein the second solenoid valve installation is actuatable by the redundant parking brake function, and the redundant parking brake function is configured so that, at least upon recognizing the fault or defect in the parking brake circuit that causes the non-energized state of the inlet/outlet solenoid valve combination, it
a) actuates the second solenoid valve installation so as to apply the at least one second service brake cylinder or to keep the at least one second service brake cylinder in an applied state and simultaneously, or thereafter, and
b) actuates the first solenoid valve installation in the pressure reduction mode.

7. The brake system of claim 5, wherein the second solenoid valve installation comprises at least one second inlet valve and at least one second outlet valve of at least one second pressure regulator module.

8. The brake system of claim 7, wherein the redundant parking brake function implemented in the at least one controller is configured so that it controls the second inlet valve and the second outlet valve so as to increase or maintain the second service brake pressure in the at least one second service brake cylinder, so as to apply the at least one second service brake cylinder or keep the at least one second service brake cylinder latter in an applied state.

9. The brake system of claim 7,
wherein the second inlet valve comprises:
a 2/2-way valve, which is monostable or bistable, and/or
a 3/2-way valve, which is monostable or bistable; and/or
wherein the second outlet valve comprises:
a 2/2-way valve, which is monostable or bistable, and/or
a 3/2-way valve, which is monostable or bistable.

10. The brake system of claim 5, wherein the second solenoid valve installation comprises a holding valve and an outlet valve of an ABS pressure control valve.

11. The brake system of claim 10, wherein the redundant parking brake function implemented in the controller is configured designed so that it closes the holding valve and the outlet valve, or keeps them closed, so as to maintain the second service brake pressure in the at least one second service brake cylinder.

12. The brake system of claim 5, wherein the redundant parking brake function implemented in the at least one controller is configured so that, once it has established by means of a reservoir pressure signal that the reservoir pressure in the at least one pressurized reservoir vessel has dropped to a pressure lower than or equal to an application pressure of the at least one spring-accumulator brake cylinder, it actuates the second solenoid valve installation so as to release the at least one second service brake cylinder.

13. The brake system of claim 5, wherein the redundant parking brake function implemented in the controller is configured so that it actuates the second solenoid valve installation to release the at least one second service brake cylinder only when it can establish by means of a first sensor signal that the vehicle is at a standstill.

14. The brake system of claim 5, wherein the redundant parking brake function implemented in the at least one controller is configured so that it actuates the second solenoid valve installation at least for a duration, or only for the duration, so as to apply the at least one second service brake cylinder or keep the at least one second service brake cylinder in an applied state, until it can establish by means of a first sensor signal that the vehicle is actually at a standstill.

15. The brake system of claim 5, further comprising:
a third sensor which directly or indirectly determines or measures a second service brake pressure prevalent in the at least one second service brake cylinder, and inputs a corresponding third sensor signal into the at least one controller.

16. The brake system of claim 15, wherein the redundant parking brake function implemented in the controller is configured so that it actuates the second solenoid valve installation so as to increase the second service brake pressure in the at least one second service brake cylinder at least until it can establish by means of the third sensor signal that the second service brake pressure has exceeded a minimum value.

17. The brake system of claim 16, wherein the minimum value for the second service brake pressure is predetermined in such a manner that, by virtue of the minimum value, a holding force is exerted on the vehicle, which corresponds at least to the parking braking force exerted on the vehicle by at least one applied spring-accumulator brake cylinder.

18. The brake system of claim 1, wherein the inlet/outlet solenoid valve combination comprises an inlet solenoid valve and an outlet solenoid valve, wherein the inlet solenoid valve is connected to the at least one pressurized reservoir vessel, and to a pneumatic control input of a relay valve, and the outlet valve is connected to a pressure sink, and to the pneumatic control input of the relay valve, a working output thereof being connected to the at least one spring-accumulator brake cylinder, and the reservoir input thereof being connected to the at least one pressurized reservoir vessel.

19. The brake system of claim 18,
wherein the inlet solenoid valve comprises:
a 2/2-way valve, which is monostable or bistable, and/or
a 3/2-way valve, which is monostable or bistable; and/or
wherein the outlet solenoid valve comprises:
a 2/2-way valve, which is monostable or bistable, and/or
a 3/2-way valve which is monostable or bistable.

20. The brake system of claim 1, wherein the first solenoid valve installation comprises at least one first inlet valve and at least one first outlet valve of a first pressure regulator module, wherein the redundant parking brake function implemented in the at least one controller is configured so that it opens, or keeps open, the first inlet valve and the first outlet valve in a temporally overlapping manner so as to lower the reservoir pressure in the at least one pressurized reservoir vessel and, as a result, to apply the at least one spring-accumulator brake cylinder.

21. The brake system of claim 20,
wherein the first inlet valve comprises:
a 2/2-way valve, which is monostable or bistable, and/or
a 3/2-way valve, which is monostable or bistable; and/or
wherein the first outlet valve comprises:
a 2/2-way valve, which is monostable or bistable, and/or
a 3/2-way valve which is monostable or bistable.

22. The brake system of claim 1, wherein the first solenoid valve installation comprises a holding valve and an outlet valve of an ABS pressure control valve, wherein the redundant parking brake function implemented in the at least one controller is configured so that it opens, or keeps open, the holding valve and the outlet valve in a temporally overlapping manner, so as to lower the reservoir pressure in the at least one pressurized reservoir vessel and, as a result, to apply the at least one spring-accumulator brake cylinder.

23. The brake system of claim 1, wherein the at least one controller in which the redundant parking brake function is implemented represents a single controller, or is distributed among a plurality of controllers, or is at least partially integrated into the electronic service brake controller.

24. The brake system of claim 5, further comprising:
at least two electro-magnetic service brake circuits, each having one pressurized reservoir vessel, and
the first solenoid valve installation and the second solenoid valve installation are constituent parts of different electro-magnetic service brake circuits, or of a single electro-magnetic service brake circuit.

25. A vehicle comprising:
the brake system of claim 1.
